(19) United States
(12) Patent Application Publication
(10) Pub. No.: US 2007/0050260 A1
(43) Pub. Date: Mar. 1, 2007

(54) Residential Ship Space Sales Method

(76) Inventor: Randall B Jackson, Mesa, AZ (US)

Correspondence Address: KLARQUIST SPARKMAN, LLP, 121 SW SALMON STREET, SUITE 1600, PORTLAND, OR, 97204, US

(21) Appl. No.: 11/468,670

(22) Filed: Aug. 30, 2006

Related U.S. Application Data
(60) Provisional application No. 60/713,307, filed on Aug. 31, 2005.

(51) Int. Cl. G06Q 20/00; G06Q 40/00

(52) U.S. Cl. 705/16; 705/35

(57) ABSTRACT

The present disclosure provides methods of selling space aboard a cruise ship. In certain embodiments, disclosed methods include incorporating a first business entity in a first jurisdiction and organizing a cooperative association. An interest in at least a portion of a ship is transferred, such as by a lease, by the first business entity to the cooperative association. The cooperative association transfers an interest in at least a portion of the ship, such as by a lease, to a consumer for the consumer's residential use. The consumer receives stock, or similar interest, in the cooperative association. The stock can be used by the consumer as collateral for a loan to finance the purchase of the ship space.

### CROSS REFERENCE TO RELATED APPLICATION

This application claims the benefit of, and incorporates by reference, U.S. Provisional Patent Application No. 60/713,307, filed Aug. 31, 2005.

### TECHNICAL FIELD

The present application relates generally to methods for selling residential space aboard a ship. More particularly, methods for selling cabins on a cruise ship through cooperative ownership are disclosed.

### BACKGROUND

Condominiums are often purchased by consumers so that the consumer has a place of their own in which to stay when they are on vacation or to use as a first or second home. However, many people enjoy visiting different places, but cannot afford condominiums everywhere they would like to visit.

Many people enjoy taking vacations on cruise ships. However, most cruise ships only offer the ability to stay aboard the ship for a limited time, typically three weeks or less. Recently, some companies have begun to sell cabins on ships to consumers on a more permanent ownership basis.

Some of these companies sell cabins in a manner analogous to condominiums, timeshares, or partial ownership arrangements. Depending on the arrangement, the consumer may stay on the cruise ship as long as they want, or a certain period of time, such as a certain number of weeks per year. The consumer may be allowed to sell or rent all or a portion of their residency rights to others, such as for periods for which the consumer is entitled to be on the ship, but does not wish to be aboard the ship. The consumer may even be allowed to completely sell their interest to another.

However, typical arrangements by which consumers can purchase residency rights aboard a ship often suffer from a number of disadvantages. For example, it is typically not possible for consumers to obtain credit to purchase space aboard the ship because the purchase of ship space does not involve real property or real estate, as opposed to typical timeshares, condominiums, and other full or part ownership arrangements. Many creditors are not used to extending substantial amounts of credit without this type of collateral. Even if financing is available, the terms may be less favorable than for other types of transactions. If sufficient sources of credit are unavailable, many consumers who otherwise may wish to purchase space aboard a ship will be financially unable to do so.

In addition to losing potential customers, the lack of available financing may create further problems. For example, many projects, such as a residential cruise ship, rely on selling a relatively large number of units in order to be profitable or practicable. Construction may not even begin on a development until a certain percentage, such as 60%, of the available units are pre-sold. If not enough units are sold, or not sold quickly enough, the project may fail. Consumers who have purchased units may be unhappy if the project does not progress. Consumers who are considering purchase may be dissuaded from purchasing if it appears that a project is languishing.

### SUMMARY

The present disclosure provides methods for selling residential space, such as space on a vessel. In some implementations, the vessel is a ship, such as a cruise ship. Certain disclosed methods are structured to allow consumers to more easily finance the purchase of space aboard the ship. However, the disclosed methods may be applied to other situations in which a consumer desires to purchase occupancy rights and the traditional incidents or indicia of ownership are not available.

According to one disclosed method, a first business entity is formed in a first jurisdiction. A cooperative association, or other entity that transfers indicia of ownership, such as stock, to its members is organized. An interest in at least a portion of a ship is transferred, such as by a first lease, from the first business entity to the cooperative association. The first lease may be for a term equal to the useful life of the structure in which ownership rights will be sold, such as the useful life of a ship. In an example where the structure is a cruise ship, the useful life, and thus the lease term, is one-hundred years.

The cooperative association transfers an interest in at least a portion of the ship to consumers, such as by a second lease. Each consumer purchases a particular unit or suite aboard the ship. In some example, the interest allows the consumer to use areas of the ship in addition to their unit, such as common areas of the ship such as restaurants, lounges, entertainment, and recreation facilities. The lease may include interest, if the purchase was financed, and charges for ship maintenance, such as a triple net lease. Maintenance charges may be apportioned to consumers on a pro rata basis and may be based on the proportion of the ship space consisting of residential space and common areas. Maintenance charges, in some examples, are based on the type of unit purchase or particular amenities desired by the consumer.

In particular embodiments, in addition to the interest in their unit, the consumer receives equity or interest, such as stock, in the cooperative association, the assets of the cooperative association, or receives other incidents of ownership that can be used as collateral for financing. Because of the availability of such collateral, more lending institutions may be willing to provide credit to the consumer or provide credit on more favorable terms. In some examples, such a lease or ownership indicia from the cooperative association to the consumer enables consumers to more easily obtain financing to purchase space aboard the ship. Compared to other methods that allow purchase of space aboard a ship, the present disclosure provides ownership structures that are more analogous to corresponding structures dealing with real property.

In further embodiments, a second business entity is organized in a second jurisdiction, which may be the same as the first jurisdiction. The second business entity transfers an interest in at least a portion of the ship to the first business entity, such as by a third lease. The third lease may be for a term equal to the useful life of the ship, such as for one-hundred years.

The jurisdictions in which the first or second business organizations or the cooperative association are organized may be chosen for favorable legal or business climates. In some examples, the cooperative association is organized under the laws of Delaware, such as being organized as a non-profit organization. In some implementations, the first or second business organization is organized in countries such as the Bahamas, Panama, and the Netherlands Antilles.

In some examples, the consumer is allowed to purchase residential space aboard the ship outright or is provided with financing options to facilitate the purchase or a component of it. In a particular example, financing is provided by the first or second business organization, the cooperative association, or an entity related thereto. In a further example, financing is provided by a fourth business organization, such as a bank, lending institution, or financial institution. Financing can be for any suitable period of time, such as for 20 years.

In some cases, the interest transferred to the consumer entitles the consumer to occupy the unit whenever and for however long the consumer wishes. In other cases, the consumer purchases a more limited ownership right. For example, the consumer may purchase the right to use the unit for a limited period of time, such as one month every year. In some implementations, the time the consumer is entitled to use the unit is fixed, such as the same month every year. In other implementations, the interest gives the consumer the right to use the unit whenever it is available up to a certain number of days every year. If the consumer does not wish to use all or a portion of their occupancy right, they may choose to rent or sell their unit to others, in particular examples.

In particular implementations, the amount of equity a consumer receives in a cooperative association corresponds to the amount of their ownership rights. For example, a consumer may receive one share for each month of residency to which they are entitled. Thus, a full-owner would be entitled to reside in the unit year-round, and would receive 12 shares in the association.

The disclosed systems and methods can provide a number of advantages. For example, because lending institutions may be more likely to finance consumers, or provide more favorable financing terms, a greater number of consumers may be interested in owning space aboard the ship. Accordingly, more units may be sold, or sold more quickly, than if such financing were not available or were available on less favorable terms.

Improved unit sales may increase the profitability of a venture or help it proceed more quickly, such as proceeding to construction more quickly if a threshold number of consumers purchase more quickly. Increased project speed may have a synergistic effect, encouraging yet more consumers to purchase, as well as potentially increasing the satisfaction of those consumers who have already purchased units.

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. Any particular embodiment need not provide all features noted above, nor solve all problems or address all issues in the prior art noted above.

### BRIEF DESCRIPTION OF THE DRAWINGS

Various embodiments are shown and described in connection with the following drawing in which:

FIG. 1 is a schematic diagram illustrating a method for selling residential space aboard a ship.

### DETAILED DESCRIPTION

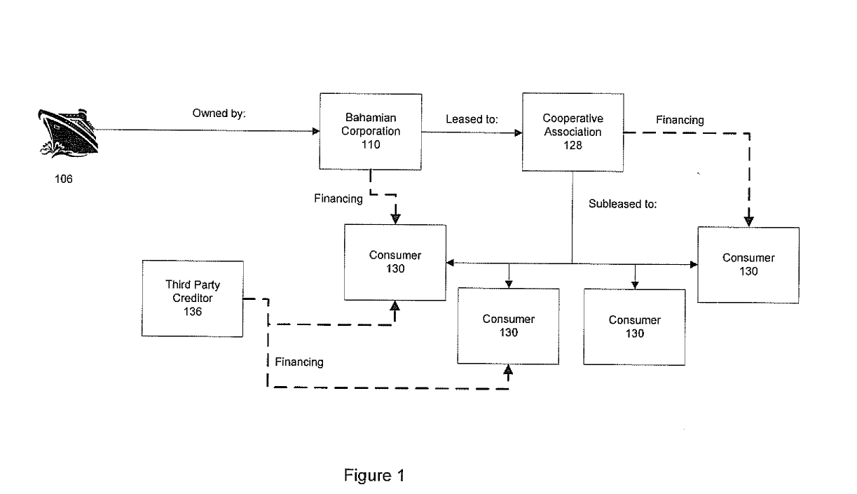

FIG. 1 is a schematic diagram of a method for selling residential space, such as space aboard a vehicle or vessel. In a particular example, described further herein, the vessel is a cruise ship.

A Bahamian corporation 110 is incorporated and purchases, or otherwise obtains an interest in, a ship 106. Incorporation in the Bahamas can provide a number of benefits, including asset protection from lawsuits, confidentiality of stockholders, lower taxes, and operational flexibility. However, the disclosed methods are not limited to Bahamian corporations or such benefits. The corporation can be formed in any suitable jurisdiction. However, particular examples use incorporation in jurisdictions having advantages at least similar to those provided by Bahamian law, such as Panama or the Netherlands Antilles. Additionally, although the present disclosure generally discusses corporations, it should be recognized that any suitable business organization may be used, including limited liability companies, partnerships, limited partnerships, limited liability partnerships, and limited liability limited partnerships.

A cooperative association 128 is organized in a suitable jurisdiction, which may be a State of the United States of America (particularly when ship space will be marketed primarily to United States citizens). Although the cooperative association 128 may be formed in any State, it may be advantageous to form the cooperative association 128 in a jurisdiction with favorable business laws, such as Delaware. Organization in such a jurisdiction may also be advantageous because other business entities, such as lending institutions, investors, and insurers, are familiar and comfortable with the laws of such jurisdictions. In particular embodiments, the cooperative association 128 is organized as a non-profit entity, which may provide a number of tax and legal benefits.

An interest in the ship 106 is transferred from the Bahamian corporation 110 to the cooperative association 128. For example, all or a portion of the ship 106 is leased by the Bahamian corporation 110 to the cooperative association 128. The lease agreement between the Bahamian corporation 110 and the cooperative association 128 may contain any desired terms. In at least certain embodiments, the lease is for a term equal to the useful life of the ship 106. For example, the lease may be for a term of 100 years for many typical cruise ships. However, in other examples the lease is for a term other than the useful life of the ship. In certain embodiments, instead of the ship 106 being leased, or other interest being transferred, directly from the Bahamian corporation 110 to the cooperative association 128, the ship 106 is leased, or an interest therein otherwise transferred, from the Bahamian corporation 110, through one or more intermediate parties (not shown), and then to the cooperative association 128.

In certain implementations of the disclosed method, the lease is for only the habitable and public areas of the ship 106. For example, the lease may be for the ship's cabins, recreation areas, dining areas, entertainment areas, and shopping areas. Other areas of the ship 106, such as control, maintenance, storage, and mechanical areas of the ship 106, are retained by the Bahamian corporation 110. In particular examples, the lease is only for the residential portions of the ship 106, and ownership of the remaining portions of the ship 106 is retained by the Bahamian corporation 110. The areas not leased to consumers may be owned and operated by the Bahamian corporation 110, the cooperative associated 128, or may be sold or leased by such parties to a third party. In this way, the cooperative association 128 or Bahamian corporation 110 may control and profit from concessions, such as shopping, restaurants, bars, gaming, and entertainment.

In some embodiments, the cooperative association 128 is set up in a manner similar to conventional housing cooperatives. The cooperative association 128 typically owns at least the portions of the ship 106 that are available for sale to the consumer 130, but may, for example, also own common areas of the ship 106. A consumer 130 can purchase, such as by a lease, a cabin, or other residential unit, on the ship 106 from the association 128. In addition, the consumer 130 can, if desired, receive one or more shares, or other interest, equity, or incident of ownership in the association 128 or its assets, including the lease between the association 128 and the Bahamian corporation 110.

Although cooperative associations are specifically described, the present disclosure is not limited to cooperative associations. Any structure that provides incidents of ownership that are analogous to conventional real estate transactions such that consumer 130 may more easily obtain financing, such as those useable as collateral to secure financing, may be used instead of or in addition to the cooperative association 128 without departing from the scope of the present disclosure.

The interest of the consumer 130 in the ship 106 is typically proprietary, such as a proprietary lease. The interest generally gives the consumer 130 the exclusive right to occupy their living space and, optionally, one or more other facilities or assets, such as a storage facility, parts, equipment, vehicles, and the like. The interest also may provide the consumer 130 with the non-exclusive right to use common areas of the boat, such as the dining areas, recreation areas, and lounge areas.

The consumer's interest may be for a whole interest in a unit or a fractional interest. For example, rather than purchasing the right to occupy the unit at any time, a consumer may, in some examples, purchase a more limited ownership right, such as the right to occupy the unit for a specific amount of time per year, such as a month per year. This partial ownership right may be for a particular time, such as a particular month, or may be a period of time that the consumer may use whenever the unit is available. In some implementations, the owner may sell or rent all of a portion of their ownership rights-such as renting their unit out when they do not wish to use it or outright selling all or a portion of their interest to another consumer.

In some implementations, the equity, such as stock, the consumer 130 receives in the cooperative association 128 correlates with the extent of ownership or residency rights of the consumer 130. In a particular example, the consumer 130 receives one share in the cooperative association 128 for every month of ownership rights the consumer 130 owns. For example, a full-owner of a unit, entitled to occupy a unit year-round, would be entitled to 12 shares in the association 128.

In at least certain embodiments, the consumer 130 is responsible for a portion of the maintenance costs of the ship 106. If the interest of the consumer 130 is a lease, the lease may be a triple net lease. For example, the cooperative association 128 may be responsible for all or a portion of the maintenance costs of the ship 106, such as costs associated with maintaining common areas of the ship 106. In a particular implementation, the portion of the operating expenses of the ship 106 allocated to the cooperative association 128 is determined by multiplying the overall operating expenses of the ship 106 by the quotient of the square footage of the ship 106 that is residential space divided by the total square footage of the ship 106 (which includes residential and commercial areas). The cooperative association 128 may then pass the operating expenses on to the consumers 130, if desired, such as on a pro rata basis. When the consumer 130 has a fractional ownership, their operating expenses can be in proportion to their share of ownership of the unit.

In some examples, the assessment is a standard assessment regardless of the actual operating costs. The standard assessment is, in particular examples, revised from time to time based on actual operating costs. In other examples, the actual operating expenses are calculated and charged to the consumers. In particular implementations, the assessment is also based on the type of unit owned by the consumer or is adjusted based on particular amenities desired by a consumer. For example, a consumer who uses a dock of the ship 106 may be charged a larger assessment based on their use of the dock.

All or a portion of the maintenance or operation of the ship 106 may be overseen by the Bahamian corporation 110 or the cooperative association 128. In particular examples, the Bahamian corporation 110 or cooperative association 128 contracts these duties out to a third party.

Consumers 130 may choose to purchase space aboard the ship 106 in a number of ways. In some implementations, the purchase is structured as a lease. If a consumer 130 has sufficient financial means, the consumer 130 can simply purchase the ship space outright. However, the consumer 130 is, in some examples, still responsible for assessments to cover operation of the ship 106. Alternatively, the consumer 130 can choose to finance the purchase. In some examples, the purchase is financed through the cooperative association 128, the Bahamian corporation 110, or a third party credit provider 136, such as a bank, lending institution, or financial institution. The purchase typically includes a lease from the cooperative association 128 to the consumer 130. Although the leases described herein are generally discussed as separate leases, two or more leases could be combined into a single lease document. In such cases, a particular “lease” refers to an ownership grant, rather than a particular document.

The disclosed configuration can be particularly advantageous when the purchase is financed by a third party credit provider 136. Third party credit providers 136 are not typically used to lending large amounts of money for the purchase of space aboard a ship, as opposed to real estate and real property. However, third party credit providers 136 are typically used to lending money for the purchase of a unit in a cooperative where the customer's stock in the housing cooperative can be used as collateral for the loan. Accordingly, third party credit providers 136 may be more likely to lend money, or offer money on more favorable terms, for the purchase of a unit on the ship through the cooperative association 128, because of the similarity to a conventional real estate transaction and because the stock the consumer 130 has in the cooperative association 128 can be used as collateral. An increase in the number of purchase options available to the consumers 130 may result in more of the consumers 130 choosing to purchase residential space on the ship 106. Moreover, having the units of the ship 106 organized as a cooperative may have other advantages, such as not being subject to laws limiting the number of condominium units in particular development.

Regardless of how the purchase is financed, the financing arrangement may take a number of forms. In a particular example, the consumer 130 pays a percentage, such as 20% or 25%, of the purchase price down with the remainder amortized over a certain time period, such as 20 years. Typically the consumer 130 is charged interest over the life of the loan. The interest can be at a fixed rate or a variable rate. The consumer 130 can typically pay off the remaining balance of the loan early, if desired.

In addition to the advantages already discussed, the disclosed systems and methods can, through the increased ease of obtaining financing, allow a greater number of consumers to purchase space aboard the ship 106. Some prior residential cruise ship projects have failed to reach completion, have been scaled back, or have otherwise have suffered financially due to the inability to sell a sufficient number of unit or sell such units quickly enough. In part, this failure to sell units is likely due to the inability of many consumers to purchase the units outright or to obtain suitable financing.

Making the units accessible to a larger number of consumers may increase both the number of units sold and the speed at which the units are sold. Increased unit sales may increase the speed at which a project can progress, as many projects do not begin construction until a certain percentage of units, such as 60%, have been sold. Increased sales also make it more likely that the project will not need to be scaled back. Both of these factors may increase the satisfaction of consumers who have purchased units, as well as driving further consumer purchases if a favorable impression of the project is created among potential purchasers.

It is to be understood that the above discussion provides a detailed description of various embodiments. The above descriptions will enable those skilled in the art to make many departures from the particular examples described above to practice methods in accordance with the present disclosure. The embodiments are illustrative, and not intended to limit the scope of the present disclosure. The scope of the present disclosure is rather to be determined by the scope of the claims as issued and equivalents thereto.

We claim:

1. A sale of residential space aboard a ship method comprising:
organizing a first business entity in a first jurisdiction, the first business entity adapted to transfer an interest in at least a portion of a ship to a cooperative organization;
organizing a cooperative association adapted to transfer an interest in at least a portion of the ship to consumers and to receive an interest from the first business entity;
transferring an interest in at least a portion of a ship from the first business entity organized in the first jurisdiction to the cooperative association;
transferring an interest in the cooperative association to consumers.

2. The sale of residential space aboard a ship method of claim 1, wherein, transferring an interest in at least a portion of a ship from the first business entity to the cooperative association comprises transferring the interest by a first lease.

3. The sale of residential space aboard a ship method of claim 2, wherein transferring an interest in at least a portion of a ship from the first business entity to the cooperative association by the first lease comprises transferring an interest in residential areas of the ship.

4. The sale of residential space aboard a ship method of claim 1, wherein the transferring an interest in the cooperative association to consumers comprises transferring stock in the cooperative association to consumers.

5. The sale of residential space aboard a ship method of claim 1, wherein the interest transferred to the consumer by the cooperative association comprises the right to occupy a unit on the ship for a period of months on an annual basis and the consumer receives one share of stock in the cooperative association for every month on an annual basis the consumer is entitled to occupy the unit.

6. The sale of residential space aboard a ship method of claim 1, wherein transferring an interest in at least a portion of a ship from the cooperative association to consumers comprises leasing a residential unit of the ship to the consumer.

7. The sale of residential space aboard a ship method of claim 1, wherein the first jurisdiction is the Bahamas, the Netherlands Antilles, or Panama.

8. The sale of residential space aboard a ship method of claims 1, wherein the cooperative association is organized in the United States of America.

9. The sale of residential space aboard a ship method of claim 1, wherein the cooperative association is organized in Delaware.

10. The sale of residential space aboard a ship method of claim 1, wherein the interest transferred to the consumer or to the cooperative association is for a term equal to the useful life of the ship.

11. The sale of residential space aboard a ship method of claim 1, wherein the interest transferred to the consumer or to the cooperative association is for a term of one-hundred years.

12. The sale of residential space aboard a ship method of claim 1, wherein the cooperative association is a non-profit corporation.

13. The sale of residential space aboard a ship method of claim 1, wherein the consumer receives stock, equity, or other interest in the cooperative association or assets of the cooperative association.

14. The sale of residential space aboard a ship method of claim 1, wherein the consumer uses the stock, equity, or other interest to collateralize a loan to purchase at least a portion of the interest in the ship transferred to the consumer.

15. The sale of residential space aboard a ship method of claim 1, further comprising providing financing to the consumer for the purchase of residential space on the ship.

16. The sale of residential space aboard a ship method of claim 15, wherein financing is provided by the first business entity or a business entity related thereto.

17. The sale of residential space aboard a ship method of claim 15, wherein the financing is provided by a bank, a financial institution, or a lending institution.

18. A method of financing the purchase of residential space aboard a ship, the method comprising providing financing for the purchase of residential space aboard a ship using stock in a cooperative association that owns an interest in the ship as collateral.

19. A cooperative association, the cooperative association comprising an interest in a cruise ship, indicia of ownership in the cooperative association, and cooperative members to which the indicia of ownership are transferred.

20. The cooperative association of claim 19, wherein the indicia of ownership comprises stock.
